(19) United States
(12) Patent Application Publication
(10) Pub. No.: US 2011/0232578 A1
(43) Pub. Date: Sep. 29, 2011

(54) Absorbent Pad Containing Corrugate

(76) Inventors: Robert T. Duke, Waxahachie, TX (US); Matt McMahan, Dallas, TX (US)

(21) Appl. No.: 13/071,180

(22) Filed: Mar. 24, 2011

Related U.S. Application Data
(60) Provisional application No. 61/317,027, filed on Mar. 24, 2010.

(51) Int. Cl. A01K 29/00; B01J 20/26

(52) U.S. Cl. 119/172; 502/402

(57) ABSTRACT

Absorbent pads comprising a filler material containing reclaimed pre-consumer cellulosic fluff and super absorbent polymer, preferably in combination with reclaimed corrugate filler as a supplemental absorbent. A method for making the subject training pads is also disclosed.

### CROSS-REFERENCE TO RELATED APPLICATION

This application claims the benefit under 35 U.S.C. 119(e) of U.S. Provisional Application No. 61/317,027, filed Mar. 24, 2010.

### TECHNICAL FIELD

This invention relates to pads comprising reclaimed materials, which pads are capable of absorbing and retaining liquids in an amount that far exceeds the weight of the pads alone. One particularly preferred application for the absorbent pads of the invention is for use as puppy training pads. The invention also relates to an economical and environmentally friendly method for making the subject pads.

### BACKGROUND

Pads useful for absorbing and holding liquids are known and include, for example: disposable diapers and other incontinency aids; hospital pads; feminine care products and puppy training pads. Such pads typically comprise an absorbent core layer. The present invention embodies technology intended to reduce or eliminate the need for using virgin fluff pulp in the manufacture of the absorbent core layer for absorbent pads, to substantially reduce the amount of expensive virgin super-absorbent polymer (“SAP”) that is otherwise needed for the production of such pads. SAP is a well known, commercially available material comprising hydrogels that absorb aqueous solutions through hydrogen bonding with water molecules.

### SUMMARY

This absorbent pads of the invention having an absorbent core manufactured from reclaimed post-production, pre-consumer scrap comprising cellulosic fluff and SAP, preferably in combination with reclaimed corrugate filler material that is also provided as a supplemental absorbent. The absorbent pads of the invention desirably further comprise a plastic backing sheet that is substantially impervious to the passage of moisture under normal use conditions and a non-woven top layer that is moisture-permeable and tear-resistant.

A method for making the novel absorbent core for the subject training pads is also disclosed. According to a preferred embodiment of the method, reclaimed, post-production, pre-consumer scrap is processed to remove most of the SAP, shredded and mixed with reclaimed corrugate, decontaminated, milled and spread onto a screen conveyor together with a controlled amount of SAP, and cut or formed to a desired size that is then applied to a plastic backing sheet and covered by a moisture permeable non-woven layer, desirably using adhesive to secure the respective layers to each other to form the absorbent pad of the invention.

When made substantially as disclosed herein, the absorbent pads of the invention embody a novel, environmentally friendly core material with outstanding liquid absorbency and wetness retention, and also exhibit a capacity for odor reduction when compared to a traditional pad. Use of the present invention reduces the associated carbon footprint of the related manufacturing process by utilizing millions of pounds of previously rejected, reclaimed pre-consumer materials per month. Pads embodying the subject technology can either supplant existing pads or provide another alternative as an eco-friendly product.

### BRIEF DESCRIPTION OF THE DRAWINGS

The absorbent pad and method of the invention are further described and explained in relation to the following FIGURES of the drawings wherein:

FIG. 1 is a simplified process flow diagram of one preferred embodiment of the method of the invention; and

FIG. 2 is a simplified cross-sectional elevation view of a section of one preferred embodiment of pad useful for absorbing and retaining liquids, the pad having an absorbent core made in accordance with one preferred embodiment of the method of the invention.

### DESCRIPTION OF THE PREFERRED EMBODIMENTS

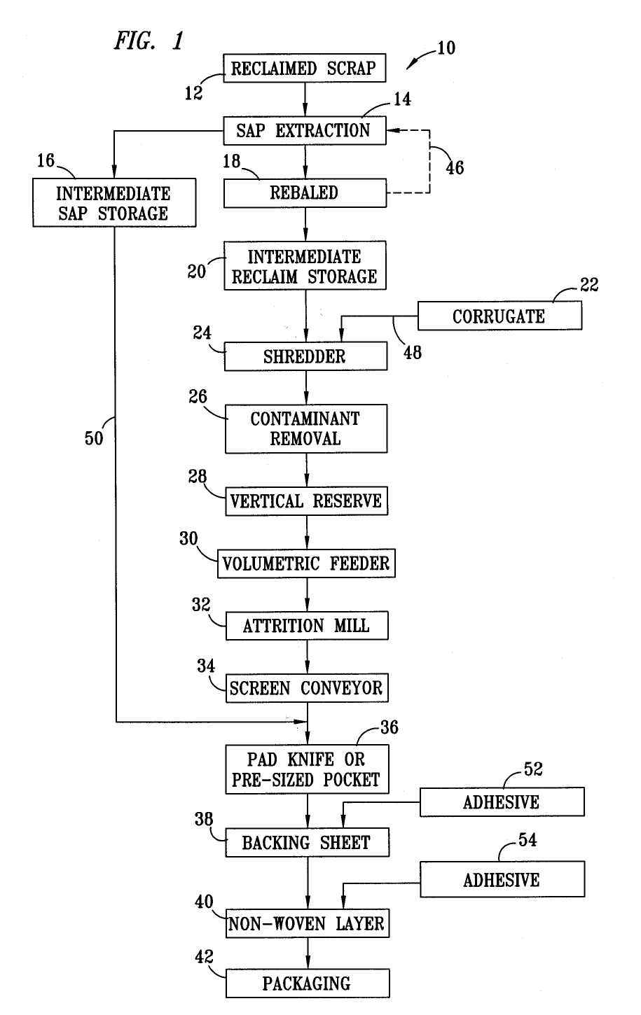

Referring to the embodiment of method 10 of the invention as depicted diagrammatically in FIG. 1, reclaimed scrap 12 comprising a major portion of fluff is preferably provided in the form of relatively clean post-production, pre-consumer, absorbent scrap such as production trimmings or rejects from the manufacture of absorbent pads used in disposable diapers and other incontinency products, hospital pads, training pads, feminine care products and the like. Such fluff scrap is commercially available in bales in at least two well-known grades, Grade #1 and Grade #3, with Grade #3 comprising a higher proportion of residual plastic (such as from backing sheets) than Grade #1. Depending upon the intended use, either grade of post-production, pre-consumer fluff scrap, or mixtures thereof, possibly in combination with another grade or type of absorbent scrap, can be used satisfactorily in producing the absorbent pads disclosed herein according to method 10 of the invention.

As noted by step 14, a major portion of the SAP present in reclaimed fluff scrap 12 is preferably extracted or removed by any suitable known method or means and is then conveyed pneumatically or otherwise to intermediate SAP storage 16, preferably into industrial bags, for subsequent reintroduction in controlled amounts into the absorbent core of the subject pads later in the process as indicated by arrow 50.

Following SAP extraction, some residual minor amount of SAP will likely remain in the post-extraction scrap. That scrap can be rebaled 18, recycled for further SAP removal as indicated by arrow 46, or otherwise stored in intermediate storage 20 pending actual fabrication of an absorbent pad.

Prior to commencing pad production in accordance with the present invention, bales of the post-extraction reclaimed fluff scrap are optionally opened and shredded or otherwise broken into manageable sized pieces. Optionally but desirably, the post-extraction reclaimed fluff scrap is combined with a portion of reclaimed corrugate filler material 22. Corrugate filler material 22 can be purchased in bales and introduced into the production line in a bale opener disposed upstream of shredder 24 as indicated by arrow 48, and then shredded, decontaminated 26 and pneumatically conveyed to a vertical reserve 28. The decontamination of method step 26 refers to the filtering out or removal of any metal contaminants that may be present in the reclaimed corrugate filler material 22. Method steps 24, 26, 28 and 30 as shown in FIG. 1 can be performed either together or in parallel for post-extraction reclaimed scrap and corrugate filler material 22. A preferred corrugate filler material 22 for use in the present invention is desirably obtained from pre-consumer sources such as, for example, corrugated cardboard boxes, die-cutting scrap, cylindrical paper cores, rejects, and the like. Such “raw materials” are widely available, are relatively free of contaminants, are readily usable without extensive cleaning or processing, and are substantially less expensive than either virgin pulp or cleaned and classified reclaimed post-consumer corrugate.

We have determined that pre-consumer corrugate has approximately 70% the absorbency of virgin pulp at a cost that is about 90% lower. The absorbent pads made using corrugate are themselves believed to be 100% recyclable except for a minor amount of glue or other adhesive used in constructing the pads. We have also determined that fiber length within the corrugate can significantly affect absorbency.

According to one preferred embodiment of the invention, an absorbent core material for an absorbent pad is made by combining, using one or more volumetric feeders 30, from about 10 to about 90 volume percent reclaimed pre-consumer fluff scrap, from about 10 to about 90 volume percent reclaimed pre-consumer corrugate, and from about 0 to about 20 volume percent SAP extracted from the reclaimed pre-consumer scrap. The reclaimed fluff scrap is preferably combined with reclaimed corrugate and then shredded, decontaminated and temporarily stored in a vertical reserve 28. From the vertical reserve, a measured quantity of the stored material is desirably charged to an attrition mill to achieve size reduction and thorough mixing of the reclaimed scrap and corrugate, and is then spread out onto a screen conveyor 34. Preferably, the particle size of the reclaimed scrap and corrugate filler material will not exceed about ¾″ mesh.

A desired amount or quantity of reclaimed SAP is desirably discharged and spread over the combined scrap and corrugate to produce the finished absorbent core material. Optionally, if desired, a controlled amount of the reclaimed SAP can be mixed with and discharged onto the screen conveyor together with the reclaimed scrap and corrugate. One or more pad knives 36 can be used to split the single web of combined reclaimed core material into several parallel webs each having smaller transverse dimensions than the original web of the material, or alternatively, the reclaimed core material may be formed in a properly pre-sized pocket on a drum. If Grade #3 reclaimed scrap is used predominantly, bits and pieces of colored plastic may be interspersed throughout and plainly visible within the mixed the combined scrap and corrugate. If Grade #1 reclaimed scrap is used predominantly, bits of colored plastic will typically be more widely scattered. Because unbleached corrugate material is typically a shade of brown, core material made using corrugate will usually have a darker color than core material made without corrugate, and core material having a higher content of corrugate will also usually have an even darker appearance, particularly when wet. It will be appreciated by those of skill in the art reading this disclosure that corrugate material will appear even darker when wet than when dry. This appearance change can in some circumstances be desirable as an additional indicator of the relative saturation level in a used pad.

The pads of the invention can then be produced by depositing a web of core material made as described above onto a backing sheet 38, typically made of polyethylene film, that is substantially impervious to moisture migration to which a glue or other adhesive 52 has been applied in suitable locations. Optionally but desirably, in addition to the method step with adhesive 52, a moisture-permeable non-woven layer of fibers 40 is preferably applied over the absorbent core material to form the multi-layer absorbent pad, and is desirably secured using adhesive 54 or another similarly effective means. The pads of the invention can be produced with the application of either adhesive 52 alone or with the application of both adhesive 52 and adhesive 54, as described above.

The resultant absorbent pads can then be packaged for storage or shipment as appropriate.

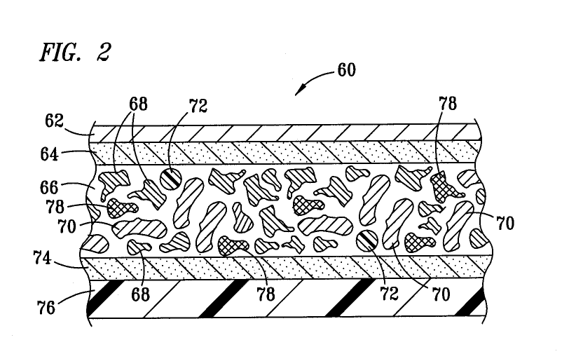

One preferred structure for the absorbent pads of the invention is further described and explained in relation to FIG. 2 wherein a simplified diagrammatic view of a segment of pad 60 is depicted that principally comprises layers 62, 64, 66, 74 and 76. It is understood, of course, that the relative thicknesses of the various layers are not drawn to scale and are not indicative of proportions. Similarly, although layers 62, 64 and 74 are depicted as being continuous within the boundaries of the segment being depicted, it should be understood, for example, that top layer 62 is intended to be porous and moisture permeable, and that layers 64, 74 are adhesive layers that can be applied in spaced-apart locations and not continuously as depicted in FIG. 2. Top layer 62 preferably comprises a plurality of randomly positioned, non-woven fibers that, although moisture permeable, are spaced closely enough to prevent particles of core layer 66 from passing through top layer 62 either prior to or during use of pad 60. Top layer 62 is also desirably sufficiently resistant to tearing that it cannot be easily ripped apart by the feet or teeth of a puppy when used in a puppy training pad. Backing sheet 76 is illustrative of a layer that is substantially impermeable to the migration of moisture under the anticipated conditions of use, preferentially as a puppy training pad. Backing sheet 76 is preferably a plastic layer comprising a polymeric film such as, for example, polyethylene having a thickness sufficient to contribute to the structural integrity of pad 60 and to resist moisture migration through sheet 76.

Layer 74 is desirably an adhesive layer that is provided in at least some sections of the pad to facilitate attachment of core material layer 66 to backing sheet 76. Core material layer 66 preferably comprises multiple particles of reclaimed scrap 68 containing cellulosic fluff, SAP 78 (including both some portion of extracted SAP that is re-introduced and some portion of residual SAP that was not extracted from the reclaimed scrap), and reclaimed corrugate 70. Small flecks 72 of plastic from the reclaimed scrap are also likely dispersed as a minor contaminant throughout layer 66, with recognition that plastic flecks 72 will occur more frequently and be more closely spaced when Grade #3 reclaimed fluff scrap is used than when Grade #1 reclaimed fluff scrap is used in making absorbent pads 60 of the invention. The interstitial spaces between the individual particles of layer 66 will be less than shown, and adjacent particles will in fact contact each other in the actual product.

Other alterations and embodiments of the invention will likewise become apparent to those of ordinary skill in the art upon reading this disclosure and the inventors intend that the scope of the invention as disclosed herein be limited only by the broadest interpretation of the appended claims to which they are legally entitled.

We claim:

1. An pad useful for absorbing aqueous liquid, the pad comprising a backing sheet that is substantially impermeable to the migration of moisture through the backing sheet, a core layer overlying the waterproof backing sheet, and a moisture-permeable top layer overlying the core layer, wherein the backing sheet, core layer and top layer are sufficiently joined to form an integral pad, wherein the core layer further comprises reclaimed absorbent cellulosic fluff and super absorbent polymer.

2. The pad of claim 1 wherein the core layer further comprises particles of corrugate.

3. The pad of claim 1 wherein the top layer is formed of randomly positioned, non-woven fibers.

4. The pad of claim 1 wherein the layers are joined by an adhesive.

5. The pad of claim 2 when configured as a puppy training pad.

6. The pad of claim 2 wherein the core layer wherein the ratio of reclaimed cellulosic fluff to corrugate ranges from about 10:90 to about 90:10.

7. A method for making an absorbent core material suitable for use in a pad for absorbing aqueous or other liquids, the method comprising:
providing reclaimed scrap containing cellulosic fluff and super absorbent polymer;
extracting a major portion of the super absorbent polymer from the reclaimed scrap;
decontaminating and reducing the reclaimed scrap to a desired particle size, and thereafter forming it into an elongate web; and
dispersing a controlled portion of the previously extracted super absorbent polymer across the web.

8. The method of claim 7 wherein a controlled amount of reclaimed corrugate filler material is combined with the reclaimed scrap.

9. The method of claim 8 wherein the corrugate filler material is combined with the reclaimed scrap prior to forming the elongate web.

10. The method of claim of claim 8 wherein the corrugate filler material is combined with the reclaimed scrap prior to reducing the reclaimed scrap to a desired particle size.

11. The method of claim 8 wherein the corrugate filler material is combined with the reclaimed scrap prior to decontamination.

12. The method of claim 8 wherein the controlled amount of reclaimed corrugate filler material ranges from about 10 to about 90 percent.
